(19) United States
(12) Patent Application Publication
(10) Pub. No.: US 2015/0109287 A1
(43) Pub. Date: Apr. 23, 2015

(54) METHOD AND SYSTEM FOR SUPPLY CHAIN NETWORK SENSITIVITY ANALYSIS AND PRESENTATION

(71) Applicant: Caterpillar, Inc., Peoria, IL (US)

(72) Inventors: Anthony James GRICHNIK, Eureka, IL (US); James Patrick FITZGERALD, Peoria Heights, IL (US); Karunya JASTI, Peoria, IL (US); Stephen KOCH, Tremont, IL (US); Joshua D. WEBB, Dunlap, IL (US); Nathan J. WEAVER, Peoria, IL (US)

(73) Assignee: Caterpillar, Inc., Peoria, IL (US)

(21) Appl. No.: 14/280,501

(22) Filed: May 16, 2014

Related U.S. Application Data
(60) Provisional application No. 61/940,946, filed on Feb. 18, 2014.
(60) Provisional application No. 61/891,974, filed on Oct. 17, 2013.

(51) Int. Cl. G06Q 10/08; G06T 11/00; G06T 11/20

(52) U.S. Cl. CPC G06Q 10/087; G06T 11/206; G06T 11/001
USPC 345/419; 345/440; 345/589

(57) ABSTRACT

A computer-implemented method for analyzing supply chain sensitivity based on a supply chain model is described. The method comprises defining a plurality of input parameters and an objective for the supply chain model Each of the input parameters includes a plurality of values within a respective range. The method further comprises obtaining a plurality of configurations of the supply chain for achieving the objective by applying the values of the input parameters to the supply chain model and generating a graphical representation for the objective based on the configurations of the supply chain. The graphical representation includes a plurality of data points, each of the data points representing a configuration of the supply chain.

### CROSS REFERENCE TO RELATED APPLICATIONS

This application claims the benefit of priority to U.S. Provisional Application No. 61/940,946, tiled Feb. 18, 2014 and U.S. Provisional Application No. 61/891,974, filed Oct. 17, 2013, which are hereby incorporated by reference in their entireties.

### TECHNICAL FIELD

This disclosure relates generally to supply chain network optimization, and more particularly, to systems and methods for supply chain network sensitivity analysis and presentation.

### BACKGROUND

Supply chain planning may be essential to the success of many of today's companies. Most companies may rely on supply chain planning to ensure the timely and reliable delivery of products in response to customer demands. Conventional supply chain planning techniques use linear programming to model functioning of different aspects of a supply chain for a particular set of constraints or conditions, such as a particular supply of components, a particular duration of transportation of finished goods from the factory to the customer, and a particular demand for a product.

For example, U.S. Patent Application Publication No. 2008/0221960A1, to Moorkanat et al. (“the '960 application”) discloses a system for optimizing supply chain planning problems associated with a supply chain network. The system disclosed in the '960 application models the supply chain planning problem as hierarchical linear programming objectives and associates each level of the hierarchy with an objective function. The system disclosed in the '960 application may generate an optimized supply chain plan by converging each optimized level of the hierarchy and communicate the optimized supply chain plan to one or more supply chain entities for implementation.

Conventional supply chain modeling techniques, such as that disclosed in the '960 application, may be inherently inaccurate, because the linear programming used in these techniques cannot correctly capture the non-linearity of critical factors in a supply chain network. In addition, conventional techniques may not allow the user to analyze the sensitivity of the supply chain network and its non-linear behavior in response to variations of the constraints and conditions. Furthermore, conventional techniques may not effectively present the sensitivity analysis to a user for viewing or guide the user to select a particular optimization result. The supply chain management system of the present disclosure is directed toward solving the problem set forth above and/or other problems of the prior art.

### SUMMARY

In one aspect, the present disclosure is directed to a computer-implemented method for analyzing supply chain sensitivity based on a supply chain model. The method comprises defining a plurality of input parameters and an objective for the supply chain model. Each of the input parameters includes a plurality of values within a respective range. The method further comprises obtaining a plurality of configurations of the supply chain for achieving the objective by applying the values of the input parameters to the supply chain model and generating a graphical representation for the objective based on the configurations of the supply chain. The graphical representation includes a plurality of data points, each of the data points representing a configuration of the supply chain.

In another aspect, the present disclosure is directed to a system for analyzing supply chain sensitivity based on a supply chain model. The system comprises a memory configured to store instructions, an input device configured to receive user inputs, an output device configured to generate a user interface, and a processor configured to receive the instructions from the memory and execute the instructions. The instructions cause the processor to define a plurality of input parameters and an objective for the supply chain model. Each of the input parameters includes a plurality of values within a respective range. The instructions further cause the processor to obtain a plurality of configurations of the supply chain for achieving the objective by applying the values of the input parameters to the supply chain model and generate a graphical representation for the objective based on the configurations of the supply chain. The graphical representation includes a plurality of data points. Each of the data points represents a configuration of the supply chain.

In yet another aspect, the present disclosure is directed to a non-transitory computer-readable medium including instructions, which, when executed by a processor, cause the processor to perform a method for analyzing supply chain sensitivity based on a supply chain model. The method comprises defining a plurality of input parameters and an objective for the supply chain model. Each of the input parameters includes a plurality of values within a respective range. The method further comprises obtaining a plurality of configurations of the supply chain for achieving the objective by applying the values of the input parameters to the supply chain model and generating a graphical representation for the objective based on the configurations of the supply chain. The graphical representation includes a plurality of data points, each of the data points representing a configuration of the supply chain.

### BRIEF DESCRIPTION OF THE DRAWINGS

FIG. 1 is a schematic illustration of an exemplary supply chain in which the supply chain sensitivity analysis system consistent with the disclosed embodiments may be implemented.

FIG. 2 is a schematic illustration of an exemplary simply chain sensitivity analysis system consistent with certain disclosed embodiments.

FIG. 3 is a flow chart illustrating an exemplary process for supply chain sensitivity analysis and presentation, consistent with a disclosed embodiment.

FIG. 4 is a schematic illustration of a user interface that the supply chain sensitivity analysis system generates for presenting analysis results, according to one embodiment.

FIG. 5 is a schematic illustration of a user interface that the supply chain sensitivity analysis system generates for presenting the analysis results, according to another embodiment.

FIG. 6 is a schematic illustration of a user interface that the supply chain sensitivity analysis system generates for presenting the analysis results, according to another embodiment.

FIG. 7 is a schematic illustration of a user interface that the supply chain sensitivity analysis system generates for presenting the analysis results, according to another embodiment.

### DETAILED DESCRIPTION

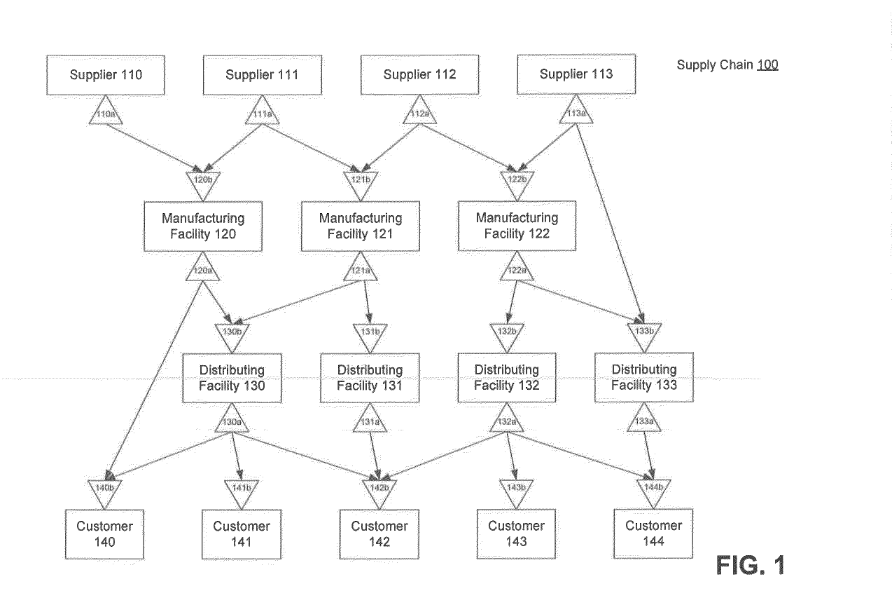

FIG. 1 illustrates an exemplary supply chain 100 in which the supply chain sensitivity analysis system consistent with the disclosed embodiments may be implemented. As shown in FIG. 1, supply chain 100 may include a plurality of supply chain entities, such as suppliers 110-113, manufacturing facilities 120-122, distributing facilities 130-133, and customers 140-144.

Suppliers 110-113 may supply individual items to one or more of manufacturing facilities 120-122, one or more of distributing facilities 130-133, and one or more of customers 140-144. An item, as used herein, may represent any type of physical good that is designed, developed, manufactured, and/or delivered by supplier 110. Non-limiting examples of the items may include engines, tires, wheels, transmissions, pistons, rods, shafts, or any other suitable component of a product.

Manufacturing facilities 120-122 may manufacture or assemble products by using one or more individual items received from suppliers 110-113. A product, as used herein, may represent any type of finished goods that is manufactured or assembled by a manufacturing facility. The product may include one or more components supplied from suppliers 110-113. Non-limiting examples of the products may include chemical products, mechanical products, pharmaceutical products, food, and fixed or mobile machines such as trucks, cranes, earth moving vehicles, mining vehicles, backhoes, material handling equipment, farming equipment, marine vessels, on-highway vehicles, or any other type of movable machine that operates in a work environment. The products manufactured by different manufacturing facilities 120-122 may be identical, or may be different from each other. Manufacturing facilities 120-122 may respectively deliver the manufactured products to one or more distributing facilities 130-133, or directly to one or more customers 140-144.

Distributing facilities 130-133 may store individual items received from one or more suppliers 110-113, and may distribute the individual items to customers 140-144 for sale as service or replacement parts for existing products. In addition, distributing facilities 130-133 may store manufactured products received from one or more manufacturing facilities 120-122, and may distribute the manufactured products to customers 140-144. In some embodiments, one of distributing facilities 130-133 may distribute the individual items or manufactured products to another one of distributing facilities 130-133, before the individual items or manufactured products are finally distributed to customers 140-144.

Although supply chain 100 shown in FIG. 1 includes four suppliers 110-113, three manufacturing facilities 120-122, four distributing facilities 130-133, and five customers 140-144, those skilled in the art will appreciate that supply chain 100 may include any number of suppliers, manufacturing facilities, distributing facilities, and dealers.

The supply chain entities in supply chain 100 may include upstream supply chain entities, such as suppliers 110-113, and downstream supply chain entities, such customers 140-144. In supply chain 100, items or products may flow in a direction from upstream supply chain entities to downstream supply chain entities. Inside each supply chain entity, at least one of a downstream inventory and an upstream inventory may be included. Downstream inventory 110a-133a may include inventories of products, parts, or subsystems that a supply chain entity may need to keep before the products, parts, or subsystems may be accepted by the supply chain entity's downstream supply chain entitles. For example, manufacturing facility 120 may include a downstream inventory 120a of products before the products can be transported to and accepted by distributing facility 130.

On the other hand, upstream inventory 120b-144b may include inventories of products, parts, or subsystems that a supply chain entity receives from the supply chain entity's upstream supply chain entities and may need to keep before the products, parts, or subsystems may be used in manufacturing or other transactional processes. In the same example above, manufacturing facility 120 may also include an upstream inventory 120b of engines from supplier 110 before the work machines may be manufactured using the engines and other parts or subsystems. Further, similar to manufacturing facility 120, suppliers 110-113 may respectively include downstream inventories 110a-113a; manufacturing facilities 121 and 122 may respectively include downstream inventories 121a and 122a and upstream inventories 121b and 122b; distributing facilities 130-133 may respectively include downstream inventories 130a-133a and upstream inventories 130b-133b; and customers 140-144 may respectively include upstream inventories 140b-144b.

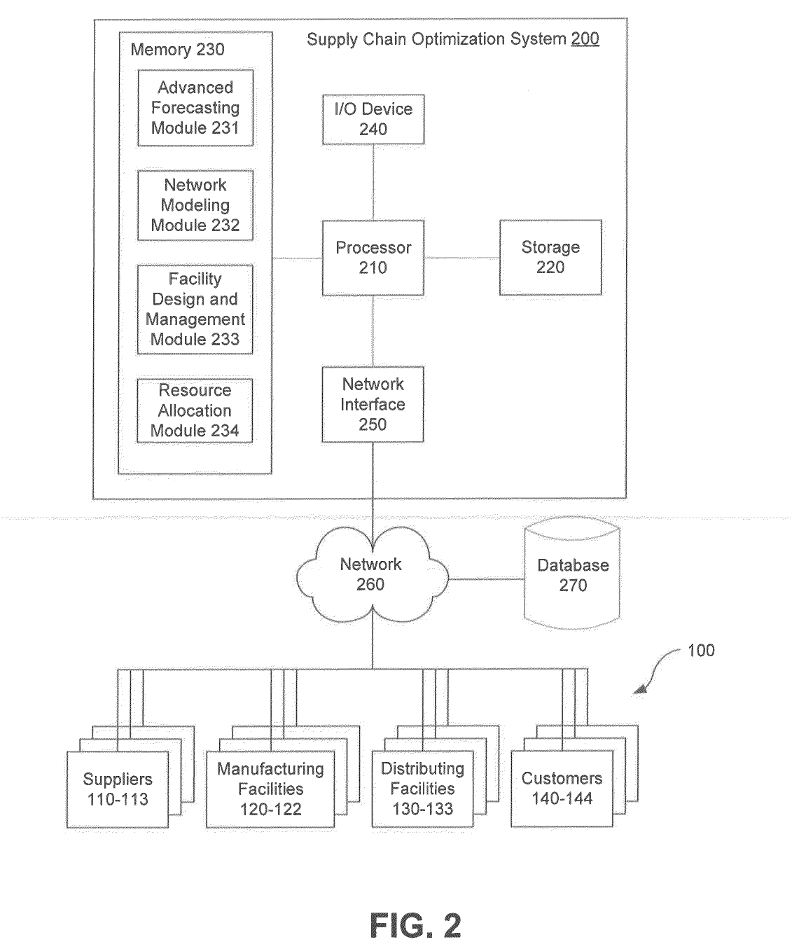

When customers 140-144 make demands to manufacturing facilities 120-122 or distributing facilities 130-133, the structure of the distribution network may be designed to fulfill the demand. The design of the distribution network may be determined according to a plurality of objectives including, for example, minimum inventory cost, maximum profit of the business, time required to fulfill the demand, environmental impact, resilience of the network, total route distance, etc. The determination may be carried out according to disclosed embodiments by an exemplary system as shown in FIG. 2. The system disclosed herein may consider one or more of these objectives simultaneously in determining the structure of the distribution network. The objectives considered by the system may be competing with one another. The system may use a nonlinear programming technique to balance the competing objectives.

FIG. 2 illustrates an exemplary supply chain optimization system 200 (hereinafter referred to as “system 200”) consistent with certain disclosed embodiments. As shown in FIG. 2, system 200 may include one or more hardware a and/or software components configured to display, collect, store, analyze, evaluate, distribute, report, process, record, and/or sort information related to logistics network management. System 200 may include one or more of a processor 210, a storage 220, a memory 230, an input/output (I/O) device 240, and a network interface 250. System 200 may be connected via network 260 to database 270 and supply chain 100, which may include one or more of supply chain entities, such as suppliers 110-113, manufacturing facilities 120-122, distributing facilities 130-133, and customers 140-144. That is, system 200 may be connected to computers or databases stored at one or more of the supply chain entities.

System 200 may be a server, client, mainframe, desktop, laptop, network computer, workstation, personal digital assistant (PDA), tablet PC, scanner, telephony device, pager, and the like. In one embodiment, system 200 may be a computer configured to receive and process information associated with different supply chain entities involved in supply chain 100, the information including purchasing orders, inventory data, and the like. In addition, one or more constituent components of system 200 may be co-located with any one of the supply chain entities.

Processor 210 may include one or more processing devices, such as one or more microprocessors from the Pentium™ or Xeon™ family manufactured by Intel™, the Turion™ family manufactured by AMD™, or any other type of processors. As shown in FIG. 2, processor 210 may be communicatively coupled to storage 220, memory 230, I/O device 240, and network interface 250. Processor 210 may be configured to execute computer program instructions to perform various processes and methods consistent with certain disclosed embodiments. In one exemplary embodiment, computer program instructions may be loaded into memory 230 for execution by processor 210.

Storage 220 may include a volatile or non-volatile, magnetic, semiconductor, tape, optical, removable, nonremovable, or other type of storage device or computer-readable medium. Storage 220 may store programs and/or other information that may be used by system 200.

Memory 230 may include one or more storage devices configured to store information used by system 200 to perform certain functions related to the disclosed embodiments. In one embodiment, memory 230 may include one or more modules (e.g., collections of one or more programs or subprograms) loaded from storage 220 or elsewhere that perform (i.e., that when executed by processor 210, enable processor 210 to perform) various procedures, operations, or processes consistent with the disclosed embodiment. For example, memory 230 may include an advanced forecasting module 231, a network modeling module 232, a facility design and management module 233, and a resource allocation module 234.

Advanced forecasting module 231 may generate forecast information related to one or more items at any one of the supply chain entities based on historical data associated with the item. For example, advanced forecasting module 231 may forecast a future demand for an item at each one of manufacturing facilities 120-122 and distributing facilities 130-133 based on respective historical demand data for that item at manufacturing facilities 120-122 and distributing facilities 130-133. In addition, advanced forecasting module 231 may forecast the future demand for the item at suppliers 110-113 by combining the forecasted demand for the item at each one of manufacturing facilities 120-122 and distributing facilities 130-133.

Network modeling module 232 may receive the forecasted information from advanced forecasting module 231 and simulate and optimize the flow of materials (i.e., items, parts, products, etc.) between the supply chain entitles and the structure of the supply chain network in order to meet certain business goals or objectives of the entire organization. The business goals or objectives may include at least one of response time, costs, profit, return on net assets, inventory turns, inventory level, service level, resilience of the supply chain net-work, costs, environmental impact, total route distance, etc. Network modeling module 232 may simulate the flow of materials and optimize the structure of the supply chain network based on a number of parameters, such as geographical locations of each one of the supply chain entities, the transportation methods (e.g., air, ship, truck, etc.). the capacities of the transportation links (e.g., quantity of materials that can be transported via a certain route), and the manufacturing capacities of the manufacturing facilities. Based on the simulation results and other information such as production costs, transportation costs, and regional sales price, and the like, network modeling module 232 may generate information such as gross revenue, cost of goods sold, and profit related to one or more products or parts.

Network modeling module 232 may further generate an optimized structure of the supply chain network based on the parameters and information discussed above. The optimized structure of the simply chain network may specify, for example, the links among the entities used to fill the demand for the item, the transportation methods used to transport materials and goods from one entity to another, the inventory level that should be maintained at each entity, etc.

Facility design and management module 233 may receive the forecasted information from advanced forecasting module 231 and the simulation results from network modeling module 232 and may determine the physical structure and dimension of one or more of manufacturing facilities 120-122 and distributing facilities 130-133 based on the received information. For example, facility design and management module 233 may receive forecasted information representing quantity of the incoming items to be received at manufacturing facilities 120-122 and distributing facilities 130-133. Based on this forecasted information, facility design and management module 233 may determine dimensions and locations of shelving, racks, aisles, and the like, of manufacturing facilities 120-122 and distributing facilities 130-133. Facility design and management module 233 may also determine the location of incoming items within manufacturing facilities 120-122 and distributing facilities 130-133, based on the forecasted information. Moreover, facility design and management module 233 may simulate the movement of resources (e.g., workers, machines, transportation vehicles, etc.) throughout manufacturing facilities 120-122 and distributing facilities 130-133 over time. Still further, facility design and management module 233 may modify input information in order to achieve one or more of the business goals.

Resource allocation module 234 may receive availability data representing the quantity of one or more items that axe available at suppliers 110-113. When the availability data is less than the forecasted demand data of the item at suppliers 110-113, resource allocation module 234 may allocate the available items at manufacturing facilities 120-122, distributing facilities 130-133, and customers 140-144 in order to achieve one or more of the business goals associated with the entire organization.

I/O device 240 may include one or more components configured to communicate information associated with ay sleet 200. For example, I/O device 240 may include a console with an integrated keyboard and mouse to allow a user to input parameters associated with system 200 and/or data associated with supply chain 100. I/O device 240 may include one or more display devices, such as monitors, or other peripheral devices, such as printers, cameras, microphones, speaker systems, electronic tablets, bar code readers, scanner, or any other suitable type of I/O device 240. System 200 may generate user interfaces through the display devices to provide optimization results to users. The user interfaces may include graphical elements and text that represent various aspects of the optimization results. System 200 may provide guidance, through the user interlaces, to assist the users to analyze and operate supply chain 100.

Network interface 250 may include one or more components configured to transmit and receive data via network 260, such as, tor example, one or more modulators, demodulators, multiplexers, de-multiplexers, network communication devices, wireless devices, antennas, modems, and any other type of device configured to enable data communication via any suitable communication network. Network interface 250 may also be configured to provide remote connectivity between processor 210, storage 220, memory 230, I/O device 240, and/or database 270, to collect, analyze, and distribute data or information associated with supply chain 100 and supply chain optimization.

Network 260 may be any appropriate network allowing communication between or among one or more computing systems, such as, for example, the Internet, a local area network, a wide area network, a WiFi network, a workstation peer-to-peer network, a direct link network, a wireless network, or any other suitable communication network. Connection with network 260 may be wired, wireless, or any combination thereof.

Database 270 may be one or more software and/or hardware components that store, organize, sort, filter, and/or arrange data used by system 200 and/or processor 210. Database 270 may store one or mere tables, lists, or other data structures containing data associated with logistics network management. For example, database 270 may store operational data associated with each one of the supply chain entities, such as inbound and outbound orders, production schedules, production costs, and resources. The data stored in database 270 may be used by processor 210 to receive, categorize, prioritize, save, send, or otherwise manage data associated with logistics network management.

### INDUSTRIAL APPLICABILITY

The disclosed supply chain optimization system 200 may efficiently provide optimized supply chain designs for any business organization to achieve one or more desired business goals or objectives. The system may then present the optimization results through one or more user interfaces and provide users with useful tools to analyze and improve the robustness, efficiency, and accuracy of the supply chain designs.

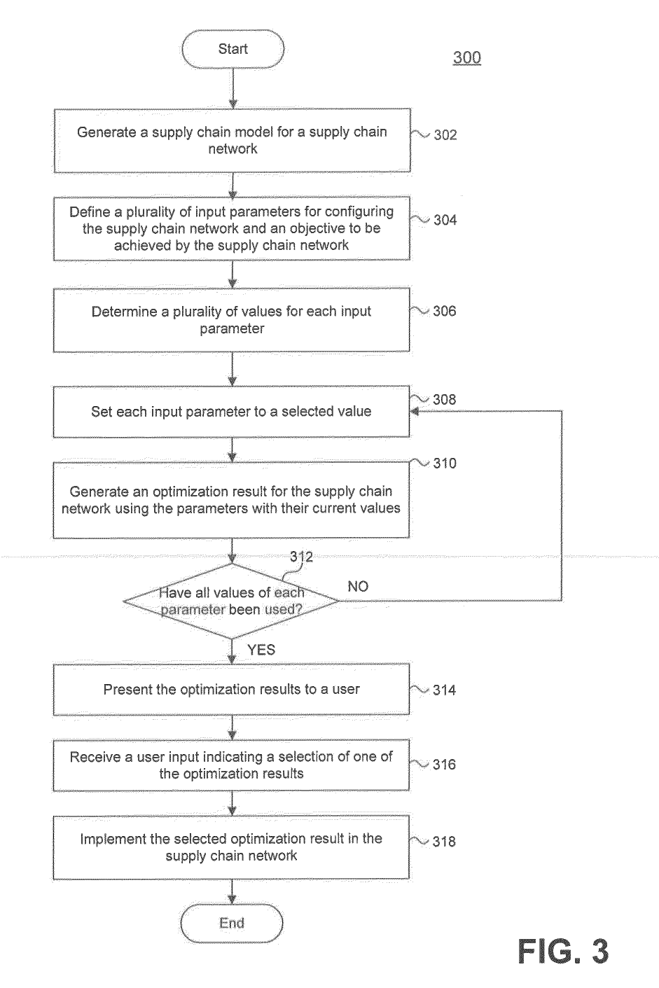

FIG. 3 is a flow chart illustrating an exemplary process 300 for presenting optimization results for a supply chain arm analyzing the sensitivity of the supply chain, according to an embodiment. According to process 300, at step 302, processor 210 may first generate a supply chain model for a distribution network or a supply chain, such as supply chain 100 of FIG. 1. The supply chain model may include a plurality of nodes representing supply chain entities, such as suppliers 110-113, manufacturing facilities 120-122, distributing facilities 130-133, and customers 140-144. Each node may have properties attached thereto to represent, for example, inventory volume, inventory cost, manufacturing capacity, or demand, etc.

In addition, the supply chain model may include a plurality of edges connecting the nodes. The edges may represent, for example, flow of materials, components, or parts from one supply chain entity to another. Each edge in the supply chain model may include one or more properties, such as transportation volume, transportation time, transportation cost, tariff, energy price, environmental impact (e.g., emission), etc. Each property of an edge may have a numerical value. The numerical value of One property may be adjusted to optimize or configure the supply chain model to achieve a given objective.

At step 304, processor 210 may define a plurality of input parameters for configuring supply chain network 100. The input parameters may include, for example, promise time, production volume, energy price, production cost, sales price, demand, etc. In one embodiment, processor 210 may define two input parameters including, for example, promise time and production volume. In order embodiments, processor 210 may define more than two parameters.

Additionally, at step 304, processor 210 may define a desired business objective to be achieved by supply chain 100. Examples of the desired business objective may include minimizing response time, maximizing profit, maximizing return on net assets, minimizing inventory cost, maximizing inventory turns, maximizing service level, maximizing a resilience of the supply chain, and minimizing the environmental impact. The resilience of a supply chain may be defined as the percentage of a resulting business goal at risk should any one of the supply chain entities perform at less than their expected performance value or fail completely. For example, referring to FIG. 1, when ail of the supply chain entities in supply chain 100 perform at their respective expected performance value, supply chain 100 may generate a profit P1. When manufacturing facility 121 fails, it is not possible to supply product to customer 142. Then, supply chain 100 may only generate a profit P2. Then, the resilience of supply chain 100 may be defined as:

Resilience=P2/P1.

As another example, the profit F of supply chain 100 may be defined as:

P=[(# of products sold)×(profit margin per product solid)]−total transportation cost of all connections in the supply chain network−total inventory cost at ail locations in the supply chain network.

At step 306, processor 210 may determine a plurality of values for each input parameters. More specifically, processor 210 may first determine a range for each input parameter and then determine the plurality of values for the input parameters within the range. In one embodiment, the values of each input parameter may be distributed uniformly within the respective range. As a result, the values of all the input parameters may form a regular grid that define a parameter space for optimizing supply chain 100. In another embodiment, the values of the input parameters may be determined according to the technique disclosed in G. E. P. Box, “Statistics for Experimenters: Design, Innovation, and Discovery,” Wiley-Interscience, 2nd Edition, May 31, 2005, which is hereby incorporated by reference.

At step 308, processor 210 may select a set of values for the input parameters from the values defined at step 306 and set the input parameters to the selected values. At step 310, processor 210 may optimize or configure supply chain 100 to achieve the defined objective by applying the input parameters with the set values to supply chain 100. Processor 210 may generate an optimization result for supply chain 100 using the set values of the input parameters. The optimization based on supply chain 100 may be performed according to various techniques known in the art. For example, processor 210 may apply the optimization methods disclosed in U.S. Provisional Application No. 61/940,946, filed Feb. 18, 2014 and U.S. Provisional Application No. 61/891,974, filed Oct. 17, 2013, which are hereby incorporated by reference in their entireties.

Using the optimization method, processor 210 may generate an optimized network structure for supply chain 100 to achieve the objective. The optimized network structure may define a configuration of the supply chain to achieve the desired objective, such as maximum profit, minimum cost; or maximum resilience, corresponding to the set values of the input parameters. In addition, the configuration of the supply chain based on the optimized network structure may indicate, for example, the route for the flow of parts or materials from a supplier to a customer, the transportation volume along each edge, the inventory level at each supply chain entity, the production volume at each supplier node, etc.

Once processor 210 completes the configuration of the supply chain model rising the selected values of the input parameters, processor 210 may proceed to step 312 to determine whether ail values of each input parameter have been used. At step 312, if processor 210 determines that there are unused values of at least one parameter (“NO” at step 312), processor 210 then returns to step 308 to select another set of values including an unused value of the input parameters.

If processor 210 determines that there are no unused value of the input parameters (“YES” at step 312), processor 210 then proceeds to step 314 to present the optimization results or the configurations of the supply chain through a user interface. The user interface may provide graphical elements or texts based on the optimization results or the configurations and allow a user to compare and analyze the optimization results or the configurations corresponding to different values of the input parameters. The user interlace will be further described below.

At step 316, processor 210 may receive a user input indicating a selection of one of the optimization results presented on the user interface. The user input may be received through a mouse, a keyboard, a touchscreen, etc. At step 318, in response to the selection of one of the optimization results, processor 210 may generate and transmit commands to supply chain 100 to implement the selected optimization result.

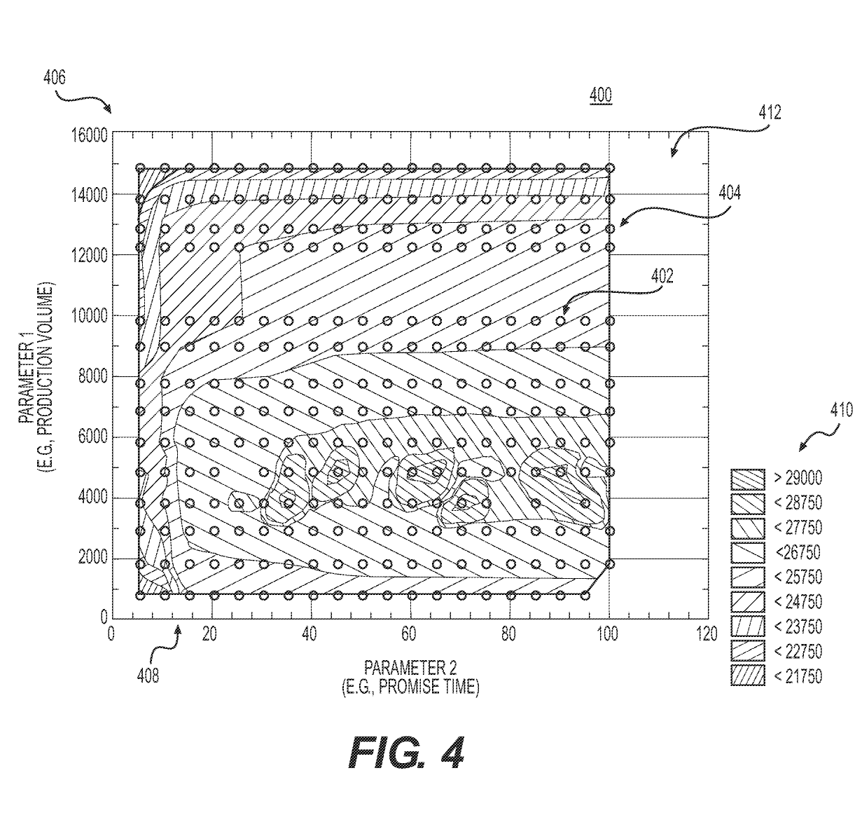

FIG. 4 illustrates an exemplary interface 400 generated by system 200 at step 314 for presenting optimization results to a user. User interlace 400 includes a plurality of data points 402 representing individual optimization results. Each data point 402 represents a value of the objective achieved by the optimized supply chain model for the given set of input parameters. In addition, each data point 402 represents a set of values of the input parameters that is used to generate the corresponding optimization result.

Data points 402 may be arranged in a coordinate system 412 including a first axis 406 and a second axis 408. First axis 406 and second axis 408 may each represent a first input parameter (e.g., parameter 1) and a second input parameter (e.g., parameter 2). For example, first axis 400 may represent production volume, and second axis 408 may represent promise time. The values of the input parameters used to obtain the optimization results are indicated on the corresponding axes. According to one embodiment, the values of the input parameters may be arranged at regular intervals along the respective axes, such that data points 402 form a regular grid. In other embodiments, the values of the input parameters may be arranged at irregular intervals, such that the data points 402 form an irregular grid.

In one embodiment, coordinate system 412 is a two-dimensional coordinate system, in which data points 402 are arranged in a data plane 404 formed by first axis 406 and second axis 408. In addition, data points 402 are color coded according to the values of the optimization results. For example, if the optimization results represent optimized profits of supply chain 100, data points 402 are color coded according to the values of the optimized profits. A set of exemplary color codes 410 is illustrated in FIG. 4, in which different colors represent different optimized profit levels.

In a further embodiment as shown in FIG. 4, spaces between data points 402 in interface 400 may also be color coded according to interpolated values. More particularly, system 200 may determine the values between data points 402 by interpolating the values of adjacent data points 402. Based on the interpolated values, system 200 may assign color codes 410 to the space between data points 402. Accordingly, the entire plane defined by the values of the first parameter and the second parameter may be color coded.

The color codes presented by interface 400 provide the user with information about sensitivity of the optimization results in response to changes in the input parameters. For example, interface 400 may show that as the promise time (e.g., parameter 2) is reduced, the profit of supply chain 100 is generally reduced. This may be due to the fact that, although a smaller promise time generally increases customer satisfaction, it may place the entire supply chain under stress, thereby increasing the operational costs of the supply chain. Similarly, interface 400 may show that as the production volume (e.g., parameter 1) is increased, the profit of supply chain 100 is also generally reduced. This may be due to the fact that, although a high production volume increases utilization of the manufacturing facilities, it may also put the entire supply chain under stress, thereby increasing the operational costs of the supply chain.

Furthermore, interface 400 may show that when the production volume is between 6000 units and 4000 units and the promise time is between 95 units and 35 units, supply chain 100 may achieve a relatively high profit. Accordingly, in this region, supply chain 100 may operate under optimal or nearly optimal conditions, thereby leading to optimal profits. Using the color codes, interface 400 may guide the user to quickly focus the analysis on the data points that correspond to globally optimal results, thereby avoiding extensive searching and guessing.

According to an alternative embodiment, interface 400 may show sensitivity of the optimization results of supply chain 100 in response to changes in the input parameters. For example, interface 400 shows that, when the production volume is at 8000 units, changes in promise time do not significantly a fleet the profit. On the other hand, interface 400 shows that, when the production volume is at 5000, the optimal profit may vary significantly in response to a small change in promise time. For example, the optimal profit may decrease substantially when the promise time changes from 65 units to 70 units. Accordingly, using the color codes, interface 400 may guide the user to determine how an input parameter may be adjusted without significantly affecting the profit of supply chain 100.

In an alternative embodiment, coordinate system 412 may be a three-dimensional coordinate system including a third axis associated representing the optimization results (e.g., optimal profits) and perpendicular to the plane formed by first axis 406 and second axis 408. System 200 may then arrange data points 402 in the three-dimensional coordinate system according to the values of the corresponding input parameters and the optimization result. System 200 may then fit a three-dimensional structure, such as a three-dimensional surface, to data points 402. Similar to the color codes described above, the three-dimensional surface may provide the user with information about the sensitivity of the optimization results in response to changes in the input parameters. For example, the three-dimensional surface may guide the user to focus the analysis on a region that corresponds to globally optimal results. The variations of the three-dimensional surface may guide the user to determine how an input parameter may be adjusted without significantly affecting the profit of supply chain 100.

According to a further embodiment, each data point 402 represents not only the values of an optimization result and the corresponding input parameters/but also a complete optimized supply chain network structure that may be immediately implemented in supply chain 100 to achieve the objective. The supply chain network structure represented by each data point 402 may include nodes representing supply chain entities and edges representing flow of materials or parts, for each supply chain entity, the data point may also specify, for example, an inventory level, a production volume, a demand for a specific part or material, etc. For each edge, the data point may specify, for example, a transportation time, a transportation cost, a transportation volume, an energy price, an environmental impact (e.g., an amount of emission or waste disposal), etc.

According to an embodiment, system 200 may select a user input indicating a selection of one of data points 402. For example, the user may select a data point that corresponds to a relatively high profit level. System 200 may receive the user input through a mouse, a keyboard, or a touchscreen.

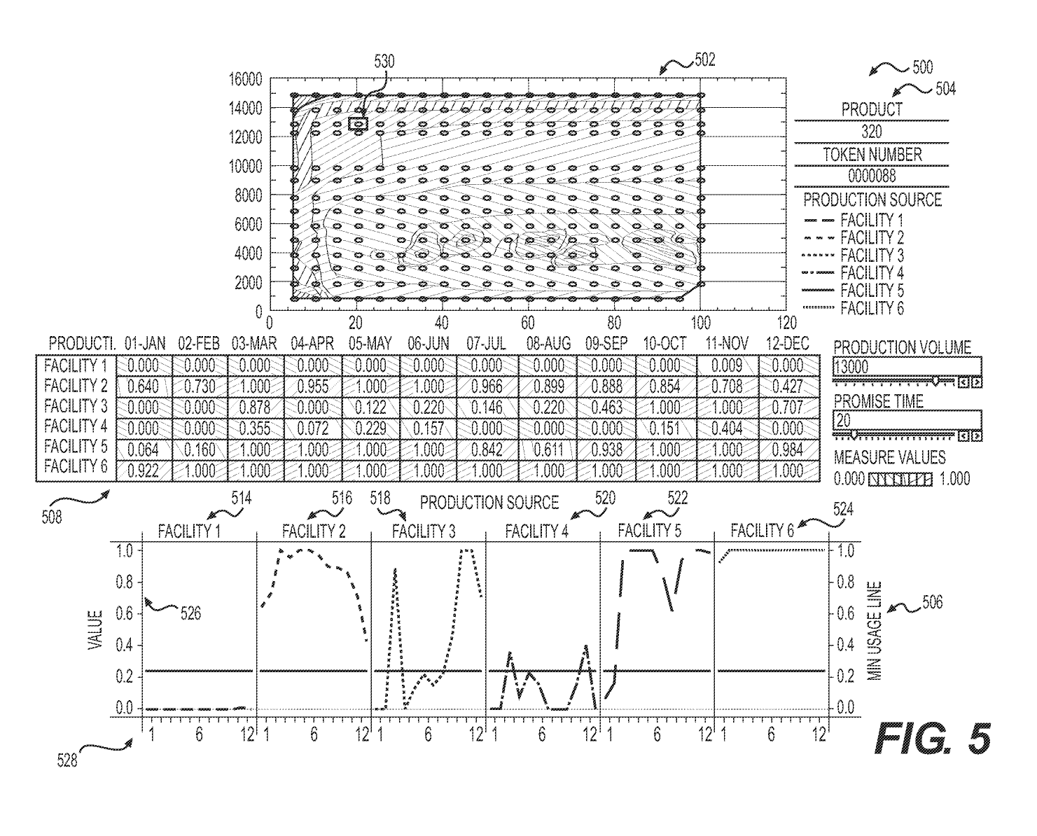

In response to the user input, system 200 may generate an interface, such as interface 500 shown in FIG. 5, providing the user with additional details of the supply chain network structure represented by the selected data point. Interface 500 may present additional details of supply chain entities 110-113, 120-122, 130-133, and 140-144 and the edges connecting the supply chain entities.

More specifically, interface 500 may include a plurality of sections 502, 504, 506, and 508. Section 502 may include a graphical representation similar to the interface shown in FIG. 4. More specifically, section 502 includes a plurality of data points representing the optimization results. The data points are arranged in a coordinate system, which has a first axis and a second axis corresponding to different input parameters used during the optimization of supply chain 100. Section 502 may further include color codes or a three-dimensional surface generated based on the optimization results. According to a further embodiment, system 200 may receive a user input indicating a selection of a data point in section 502. In response to the user input, system 200 may present additional details of the selected data points in sections 504, 506, and 508, which will be described below.

Section 504 may include, for example, an identification of the product that the supply chain provides, a token number, and a list of production sources. The list of production sources may identify manufacturing facilities or plants within supply chain 100 that have the capacity to produce the product. Each production source may be identified by a source identification and/or a geographical location of the production source. In addition, each production source may be assigned a color code uniquely identifying the production source. Section 504 may further include information that identifies the selected data point. For example, when data point 530 in section 502 is selected, section 504 may display the value of the production volume (i.e., 13000 units) and the value of the promise time (i.e., 20 days) that correspond to data point 530.

Section 506 of interface 500 may include a plurality of curves 514-524 presented in separate coordinate systems, each corresponding to one of the production sources shown in section 502. Each curve in section 506 represents planned or estimated production volumes at the respective production sources. A planned production volume is a volume of a product that the production source is expected to produce at a given time. Each coordinate system in section 506 may include a first axis 526 representing the planned production volume at the corresponding production source and a second axis 528 representing a time period, such as a week, a month, a year, etc. The production volume represented by axis 526 may be normalized and have a range between 0.0 (or 0%) and 1.0 (or 100%), representing the fraction of the production capacity that is being used at a given production source. Each of curves 514-524 represents variations of the planned production volume within the given time period at the corresponding production source. Curves 514-524 may be color-coded according to the colors assigned to the production sources in section 504, so as to help identification of me curves with the corresponding production sources.

Section 508 may include a table that presents the plumed productions volumes in numerical form. In particular, the table in section 508 may present numerical values of the planned production volumes at the production sources within the specified time period. For example, each row of the table corresponds to a production source and includes numerical values of the planned production volumes at different times at the corresponding production source. Each cell of the table may include an average value of the planned production volume within, for example, a month. In addition, the cells of the table may be color coded according to their respective average values of the planned production volumes.

According to an embodiment, interlace 500 allows the user to visually compare the planned production volumes at different production sources within the specified time period and adjust the supply chain 100 accordingly. For example, when the user selects data point 530, sections 506 and 508 may guide the user to identify imbalance between different production sources. More particularly, interface 500 may show that the source in Facility 1 has very low production volumes throughout the entire time period, while the source in Facility 6 has very high production volumes throughout the entire time period. Sections 506 and 508 may also guide the user to identify imbalance between different points in time within a production source. For example, interface 500 may show that the source in Facility 3 has high production volumes at the beginning and end of each calendar year, while very low production volumes in the middle of the calendar year. Based on this information, interface 500 may then guide the user to select a different data point in section 502 so as to achieve more balanced production volumes between production sources and within production sources. As a result, interface 500 may provide guidance and assist the user to select an optimization result for operating the supply chain to achieve a desired objective as well as managing individual supply chain entities to increase resilience and reliability of the supply chain.

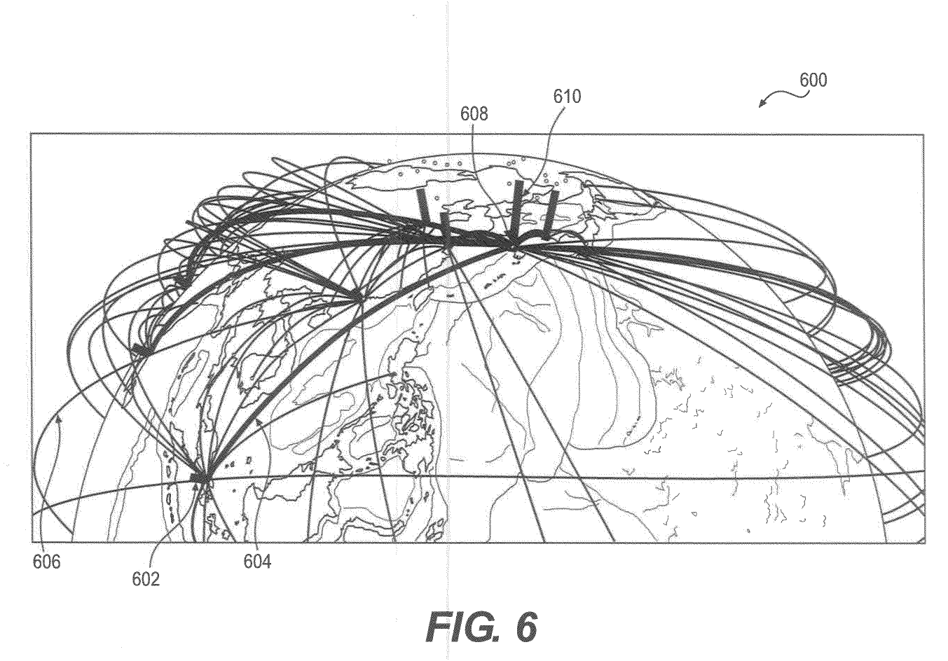

FIG. 6 illustrates another user interface 600 generated by system 200 for presenting optimization results, according to another embodiment. Interface 600 may display a graphical representation of an optimized supply chain including a plurality of nodes 602 and 608 representing supply chain entities and a plurality of edges 604 and 606 representing flow of materials or parts within the supply chain. Nodes 602 and 608 may be mapped to a world map or a globe according to the geographical locations of the respective supply chain entities.

Edges 604 and 606 may be representing by lines connecting nodes 602 and 608. System 200 may assign different thicknesses to the lines according to properties of respective edges 604 and 606, such as transportation costs, transportation volumes, energy prices, etc. For example, an edge (e.g., edge 604) that has a relatively high transportation volume may be assigned a relatively thick line, while an edge (e.g., edge 606) that has a relatively low transportation volume may be assigned a relative thin line. Thus, interface 600 may provide the user with immediate visualization of information about the properties of the edges. Using this information, interface 600 may then guide the user to arrange and negotiate for transportation services among the supply chain entities. For example, an operator of the supply chain network may negotiate a transportation service contract with a shipping service for each edge based on respective transportation volumes indicated by the lines. For an edge with a relatively thick line, interface 600 may guide the operator to negotiate for a relatively favorable price because of the relatively high volume. For an edge with a relatively thin line, on the other hand, interface 600 may indicate to the operator that spending a great deal of effort to negotiate for a relatively favorable price may not be worthwhile or possible.

In addition, interface 600 may include a bar element 610 for each node. Bar element 610 may have a height that is determined according to the inventory level at the corresponding supply chain entity. For example, a relatively high bar element may indicate a relatively high inventory level, while a relatively low bar element may indicate a relatively low inventory level. Thus, interface 600 may provide the user with an immediate visualization of inventory information at the supply entitles throughout the supply chain network. Using this information, interlace 600 may guide an operator of the supply chain network to arrange storage facilities and services for each supply chain entities. For example, for a node with a relatively high bar element, interface 600 may prompt the operator to negotiate for a relatively favorable price because of the relatively high inventory level. For a node with a relatively low bar element interface 600 may indicate to the operator that spending a great deal of effort to negotiate for a relatively favorable price is probably not worthwhile or possible.

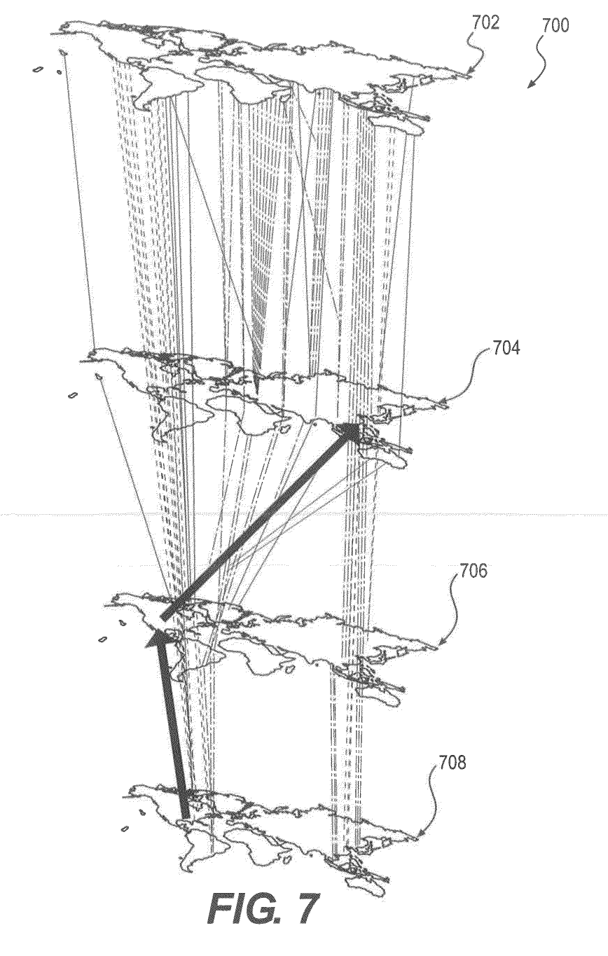

FIG. 7 illustrates another user interface 700 generated by system 200 for presenting optimization results, according to another embodiment. Interface 700 includes a plurality of nodes representing the supply chain entities arid a plurality of edges connecting the nodes for modeling the flow of materials and parts. The nodes in interface 700 are arranged in a plurality of groups, including a group of supplier nodes 708 representing suppliers, a group of manufacturing nodes 706 representing manufacturing facilities, a group of distribution nodes 704 representing distribution facilities, and a group of customer nodes 702 representing customers. Each group of nodes is mapped to a world map according to the geographical location of the respective supply chain entities.

The edges are represented by lines connecting the nodes. Similar to interface 700, the lines in interface 700 may have thicknesses determined according to values of properties of the corresponding edges, such as the transportation volumes, transportation costs, energy prices, etc. Interface 700 may also include graphical elements indicating the inventory volumes at the supply chain entities. Thus, interface 700 may also provide the user with visualization information to assist the user in planning the implementation of the supply chain and negotiating relevant services. In addition, interface 700 may provide the user with additional information on how the materials and parts flow between different types of supply chain entities and the properties of the edges that connect the different types of supply chain entities.

Interface 600 and interlace 700 may also be configured to animate the various elements of their displays in response to changing conditions in the supply chain. For instance, system 200 may determine changes in the input parameters (e.g., promise time, production volume, etc.) anticipated over time due to varying market conditions, supply strategies, and the like. System 200 may then modify (e.g., increase or decrease) the thicknesses of the edges in interface 600 and interface 700 in response to the change. System 200 may also make the edges appear or disappear for similar reasons. Likewise, system 200 may determine a change in anticipated inventor levels and modify the bars in interface 600 in response to anticipated inventory levels. For example, system 200 may increase or decrease the sizes or heights of the bars and remove or add the bars to interface 600. One of ordinary skid in the an will appreciate that other parameters could be used to drive such animations, such as varying customer demand levels, varying deliver times, and other items that may appear on the axes of FIG. 4.

One of ordinary skill in the art will recognize that system 200 may use other graphical elements to represent the properties of the edges and supply chain entities of the supply chain. For example, instead of using thickness to illustrate the properties of the edges, the system may use color codes or other graphical features to indicate different property values associated with the edges. It will be apparent to those skilled in the art that various modifications and variations can be made to the disclosed supply chain optimization system. Other embodiments will be apparent to those skilled in the art from consideration of the specification and practice of the disclosed supply chain optimization system. It is intended that the specification and examples be considered as exemplary only, with a true scope being indicated by the following claims and their equivalents.

What is claimed is:

1. A computer-implemented method for analyzing supply chain sensitivity based on a supply chain model, comprising:
defining a plurality of input parameters and an objective for the supply chain model, each of the input parameters including a plurality of values within a respective range;
obtaining a plurality of configurations of the supply chain for achieving the objective by applying the values of the input parameters to the supply chain model; and
generating a graphical representation for the objective based on the configurations of the supply chain, the graphical representation including a plurality of data points, each of the data points representing a configuration of the supply chain.

2. The method of claim 1, further comprising;
receiving a user input representing a selection of one of the data points; and
configuring the supply chain according to the configuration represented by the selected data point.

3. The method of claim 1, wherein the graphical representation indicates variations of a value of the objective as a function of the input parameters.

4. The method of claim 3, wherein the graphical representation includes color codes assigned to the data points based on the configurations of the supply chain, the color codes indicating the variations of the value of the objective as a function of the input parameters.

5. The method of claim 4, wherein the graphical representation includes a three-dimensional surface fitted to the values of the objective.

6. The method of claim 1, wherein the graphical representation includes a first axis representing the values of a first one of the input parameters and a second axis representing the values of a second one of the input parameters, and
wherein the data points are arranged in the graphical representation according to the first axis and the second axis.

7. The method of claim 1, wherein the input parameters are selected from a group including production volume, promise time, production cost, sales price, demand, energy cost, inventory carrying cost, or tariff.

8. The method of claim 2, further comprising generating a second graphical representation for the selected data point in response to the user input
wherein the second graphical representation includes a plurality of graphical elements associated with a plurality of supply chain entities.

9. The method of claim 8, wherein each of the graphical elements represents a variation of a parameter of the associated supply chain entity.

10. The method of claim 9, wherein the parameter of the associated supply chain entity includes at least one of a demand, a supply, a production volume, a transportation volume, a transportation cost, a transportation time, an inventory carrying cost, an inventory volume, a tariff, or an energy price.

11. The method of claim 9, wherein:
the supply chain entities include a plurality of manufacturing sites; and
the graphical elements represent variations of estimated production volumes of the respective manufacturing sites over a predetermined period of time.

12. The method of claim 9, wherein:
the simply chain entities include a plurality of transportation routes; and
the graphical elements represent estimated transportation volumes of the transportation routes.

13. The method of claim 1, wherein the graphical elements further represent inventory volumes of the supply chain entities.

14. The method of claim 1, wherein the graphical representation including a graphical element representing the objective of supply chain model, and
the method further comprising:
determining a change in the values of the input parameters; and
modifying the graphical elements in response to the change in the values of the input parameters.

15. A system for analyzing supply chain sensitivity based on a supply chain model, comprising:
a memory configured to store instructions;
an input device configured to receive user inputs;
an output device configured to generate a user interface;
a processor configured to receive the instructions from the memory and execute the instructions, the instructions causing the processor to:
define a plurality of input parameters and an objective tor the supply chain model, each of the input parameters including a plurality of values within a respective range;
obtain a plurality of configurations of the supply chain for achieving the objective by applying the values of the input parameters to the supply chain model; and
generate, through the output device, a graphical representation for the objective based on the configurations of the supply chain, the graphical representation including a plurality of data points, each of the data points representing a configuration of the supply chain.

16. The system of claim 15, wherein the instructions further cause the processor to:
receive, through the input device, a user input representing a selection of one of the data points; and
configure the supply chain according to the configuration represented by the selected data point.

17. The system of claim 15, wherein the graphical representation indicates variations of a value of the objective as a function of the input parameters.

18. The system of claim 17, wherein the graphical representation includes color codes assigned to the data points based on the configurations of the supply chain, the color codes indicating the variations of the objective as the function of the input parameters.

19. The system of claim 15, where the instructions further cause the processor to generate a second graphical representation for the selected data point in response to the user input,
wherein the second graphical representation includes a plurality of graphical elements associated with a plurality of supply chain entities.

20. A non-transitory computer-readable medium including instructions, which, when executed by a processor, cause the processor to perform a method for analyzing supply chain sensitivity based on a supply chain model, the method comprising:
defining a plurality of input parameters and an objective for the supply chain model, each of the input parameters including a plurality of values within a respective range:
obtaining a plurality of configurations of the supply chain for achieving the objective by applying the values of the input parameters to the supply chain model; and
generating a graphical representation for the objective based on the configurations of the supply chain, the graphical representation including a plurality of data points, each of the data points representing a configuration of the supply chain.
